(19) United States
(12) Patent Application Publication
(10) Pub. No.: US 2016/0178108 A1
(43) Pub. Date: Jun. 23, 2016

(54) REPAIR AND REINFORCEMENT OF PRESSURIZED PIPES

(71) Applicant: Mohammad Reza Ehsani, Tucson, AZ (US)

(72) Inventor: Mohammad Reza Ehsani, Tucson, AZ (US)

(21) Appl. No.: 14/574,259

(22) Filed: Dec. 17, 2014

(51) Int. Cl. F16L 55/165; B29C 43/02; B29C 43/18; B29C 43/10

(52) U.S. Cl. CPC F16L 55/165; B29C 43/10; B29C 43/021; B29C 43/18; B29L 2023/22

(57) ABSTRACT

Method and articles of manufacture are described for internally reinforcing and/or repairing various pipes, especially those carrying pressurized gas or liquids. In various embodiments a radially expandable tube is first inserted into or is pulled through the pipe. This radially expandable tube may be pre-saturated in epoxy before or after entering the pipe. Subsequently, an apparatus such as a balloon is passed through the tube which forces the tube to expand and come in contact with the inside surface of the pipe. In some embodiments epoxy is sprayed on the tube as the balloon moves inside the tube. When the epoxy-saturated tube comes in contact with the inside surface of the pipe and adheres to the pipe and cures, it forms an intimate liner for the pipe, which can add strength to the pipe in multiple directions and or prevent any leakage of the content of the pipe.

### CROSS-REFERENCE(S) TO RELATED APPLICATION(S)

This non-provisional application is related to U.S. provisional patent applications No. 61/962,358 filed on Nov. 06, 2013, entitled “CONSTRUCTION AND REPAIR OF PIPES WITH BRAIDED FRP TUBE,” the disclosure of which is hereby expressly incorporated in its entirety by reference.

### TECHNICAL FIELD

This application relates generally to piping and pipe construction. More specifically, this application relates to methods and apparatus for reinforcement and/or repair of pressurized pipes, using inner liners.

### BRIEF DESCRIPTION OF THE DRAWINGS

The drawings, when considered in connection with the following description, are presented for the purpose of facilitating an understanding of the subject matter sought to be protected.

FIGS. 1 and 2A and 2B show example expandable inner tubes for reinforcement and/or repair of pressurized pipes;

FIG. 3 shows an example method for inserting an inner tube in to a pipe;

FIG. 4 shows an example mechanism for expanding an inner tube and bonding or attaching it to the inside wall of a pipe; and

FIG. 5 shows another example mechanism for expanding an inner tube and bonding or attaching it to the inside wall of a pipe and curing the resin.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description mostly references using a flexible braided tube, an overlapped inner tube, and a collapsible tube, it will be appreciated that the disclosure may include other types of expandable tubes such as unbraided tubes or braided overlapped tubes, and the like.

Pipelines often corrode and deteriorate with age, requiring repairs. An example is the recent San Bruno, Calif. gas pipe failure of a 30-inch steel pipe that killed eight and caused millions of dollars of damage. The NTSB (National Transportation Safety Board) investigation following the explosion concluded that faulty welds in the 50+ year old pipe were a major cause of failure. There are thousands of miles of such pipelines that must be repaired. As reported by San Francisco Chronicle, PG&E officials estimated the cost of the mandated repairs to be around $11.3 billion. Clearly, in many cases removal and replacement of these transmission lines is not feasible. Economic methods and products for repair of such pipes that minimize digging are needed.

In addition, there are cases where the pipe is not damaged but may require strengthening so the gases or fluids can be transported at a higher pressure which would allow a larger volume of materials to be transported through the pipe per hour. The methods presented in the present disclosure can be used to repair and/or strengthen such pipes and allow larger put-through volumes. Furthermore, there are leaking pipes which can be repaired by the presented methods to make them watertight and to stop the leakage.

The existing technologies for repair of pipelines have many limitations and shortcomings. Some companies use fiberglass tubes that are made to match the exact diameter of the pipe being repaired. Pieces of these tubes, about 1000 feet or so long, are placed in a thin plastic bag and are saturated with various resins. Then the entire assembly is forced into the pipe by an inversion process which places the resin-saturated fiberglass tube against the host pipe and keeps the dry and clean face of the plastic bag facing the inside of the pipe. Steam, hot air, or UV light is then used to cure the fiberglass tube in place, against the host pipe. Such techniques have several shortcomings such as:
1. The repairs must be performed from manhole to manhole; that is the repairs must be performed on the full length of the pipe (or very long portions); the method is not feasible for spot repair or repair of short segments of a pipe;
2. The curing of the fiberglass tube requires heat, steam or UV which add cost and time to the repair;
3. The tube cannot accommodate bends; when the pipe has a 60 degree bend, for example, the tube, which is made for a fixed diameter, cannot deform to that geometry. As a result the tube will buckle at that location and will not remain in full contact with all points in the host pipe; the portions of the tube on the inside diameter (smaller) corner will buckle while the portions of the tube on the outside diameter (larger) will not be able to reach and stay in contact with the host pipe. This is a major shortcoming of these products that leads to a “choking” of the tube at each bend; and
4. The fiberglass tubes have limited strength and cannot typically be used to increase the pressure rating of a pipe.

To overcome the above shortcomings and provide additional functions and uses, new methods for repairing and/or reinforcement of pipes are disclosed herein.

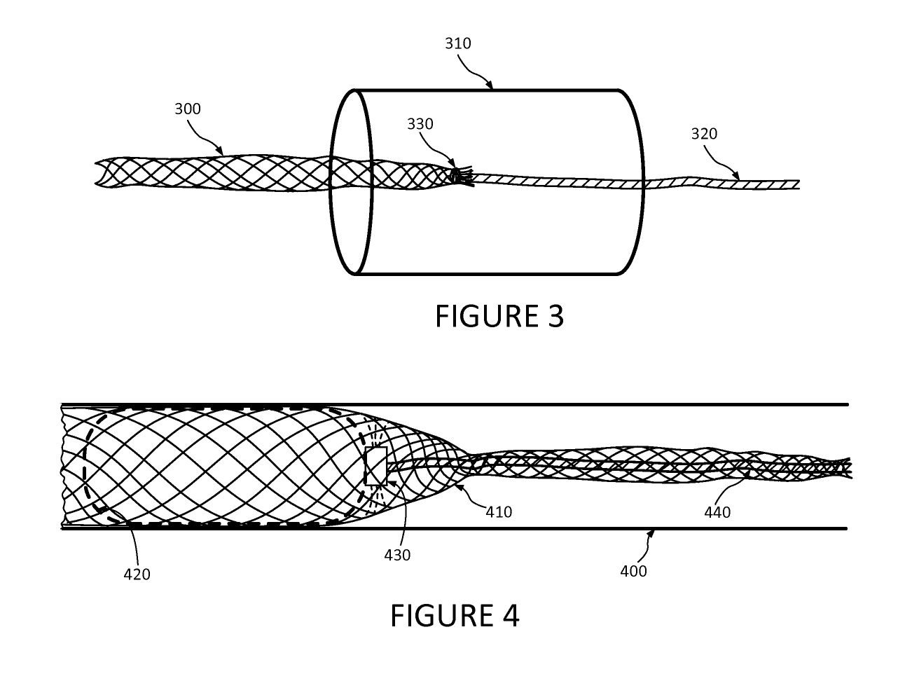

Briefly described, methods and articles of manufacture are disclosed for internally reinforcing various pipes that are constructed from different materials including but not limited to steel, concrete, masonry, wood, fiberglass, plastics, and the like. Some of the various pipes may be used to carry pressurized water, gas, oil, and the like. In an embodiment of these methods at least a layer of a flexible, bendable, radially expandable tube is first inserted into or is pulled through the inside of a desired pipe. These tubes, for example, may be braided (such as those supplied by A&P Technology, Cincinnati, Ohio), woven, or unwoven tubes or overlapped sheets of materials or longitudinally-folded or longitudinally collapsed tubes that are made of carbon, glass, basalt, Kevlar or other fibers. In various embodiments the inserted radially expandable tube may be pre-saturated in epoxy. FIG. 3 illustrates an expandable tube 300 being pulled through a pipe 310 by a rope or cable 320 that is attached or tied to the expandable tube 300 at point 330.

In a subsequent step an expansion apparatus, such as a balloon, is passed through the radially expandable tube which forces the radially expandable tube to touch all around the inside wall of the pipe. In embodiments in which the radially expandable tube is not pre-saturated with epoxy, an epoxy spray may be attached to the leading side of the expansion apparatus/balloon or be moved in front of the apparatus and spray epoxy on the radially expandable tube ahead of the expansion of the tube. In either case, when the epoxy smeared expandable tube comes in contact with the inside surface of the pipe and adheres to it, a strong and integrated liner is formed inside the pipe and becomes an integral part of the pipe. Depending on the designed characteristics of this liner, it can add strength to the pipe in multiple directions, including radial, longitudinal, and transverse, and/or prevent any leakage of the content of the pipe.

The presented methods also work well on large diameter pipes where man entry is possible and the crew can enter the pipe through access ports and apply the radially expandable tube to the pipe's inside surface manually or using a device. The described methods are equally suitable for small-diameter pipes where man entry is not feasible and the radially expandable tube must be installed using mechanical devices. These methods can be utilized to repair long portions of a pipe or to repair and reinforce only certain spots (typically shorter lengths) that require repair.

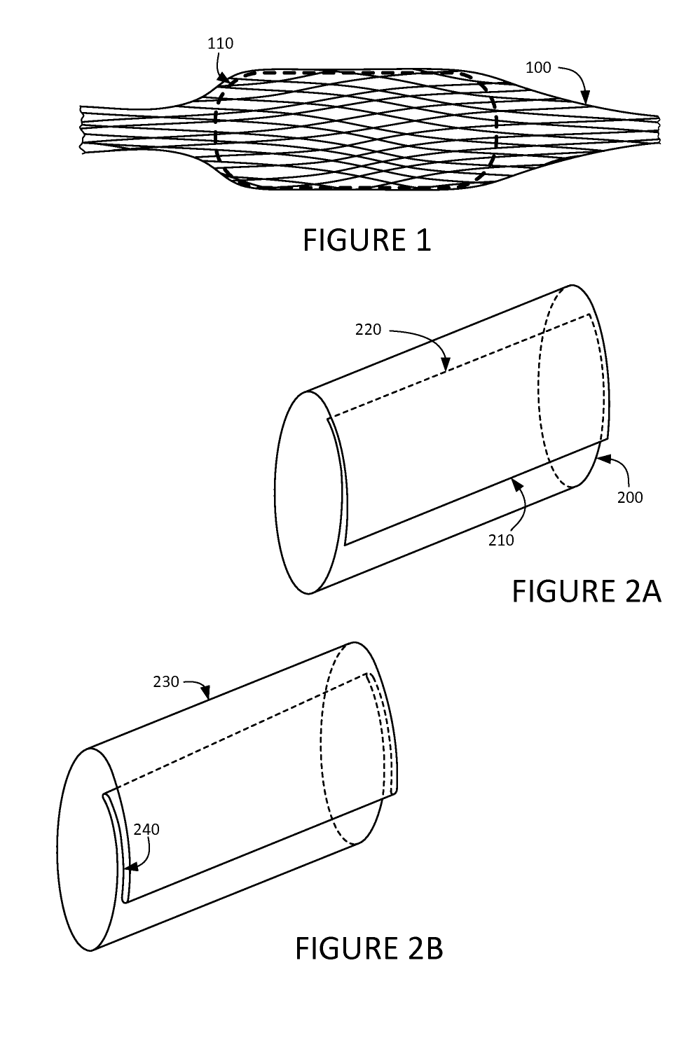

In various embodiments, the radially expandable tube may be a woven or braided tube made of high strength strands, such as the one shown in FIG. 1, or may be a rolled and overlapped sheet of material, such as the one illustrated in FIG. 2A, or a longitudinally folded or collapsed tube, such as the one illustrated in FIG. 2B, either one of which can easily enter a pipe and can subsequently expand to be attached to the inside surface of the pipe. In FIG. 1, an expanding device/bladder 110 has expanded a local region of a braided tube 100. As illustrated in FIG. 2A, the two edges 210 and 220 of a sheet of desired material have overlapped each other to form an expandable tube 200. An expandable device/balloon within tube 200 will change the amount of overlap of edges 210 and 220 which in turn will change the radial size of tube 200. FIG. 2B shows a tube 230 that has been folded longitudinally at section 240 to reduce its radial size for insertion into a desired pipe before expansion.

The radially expandable carbon biaxial tubes or sleeves have the cosmetically desirable appearance of a 2×2 Twill pattern but as a tube they can be slid over a prepared mandrel or tube to create straight or tapered tubing. Similarly, they can be saturated with resin and slid inside a tube or pipe and pressed and cured while being pressed against the pipe surface to repair and strengthen the pipe. Some radially expandable tubes can be increased from their base diameter up to 30% and decreased up to 70%. This means that a 20″ diameter radially expandable tube can be used in a single application to fit inside a pipe with variable diameter ranging from 6″ to 26″. Laying up radially expandable tubes is predictable, repeatable, and suitable for precise manufacture of composite parts. Expandable carbon biaxial tubes are extremely resistant to cracks between layers created by multiple concentric tubes, reducing the possibility of delaminating and increasing the strength of the product. This is very helpful when more than one layer of the tube is used to repair a pipe. When inflated, braided reinforcement orients itself to the direction of force. This actually strengthens its outer skin, enabling it to withstand pressure and carry load, and to tolerate damage and fatigue. If a puncture does occur, the tube provides a slow, controlled failure, rather than a more damaging and potentially catastrophic blowup. Expandable tubes also completely conform to the shape of products with changing geometries. The expandable tubes may have the following features:
a) Can be made of carbon, glass, Kevlar, basalt, polyester, or other metallic and non-metallic fiber;
b) Can be constructed having multiple layers for added strength, for example, a tube in a tube;
c) If using carbon flexible tubes for repair of a steel pipe, galvanic corrosion is a concern. In that case, carbon flexible tubes may be encased in a thin glass fabric or polyester fabric (either in sheet form or in the form of stretchable flexible tubes) such that when the system is installed, the fiberglass or polyester tube is in contact with the steel pipe and serves as a dielectric barrier to prevent direct contact between the carbon flexible tubes and steel pipe; the type of resin used between the flexible tubes and the internal surface of the pipe being repaired may be an additional barrier to galvanic corrosion; and
d) The expandable tubes can be designed to work in conjunction with the host pipe to jointly resist the loads, or they can be designed to act independently of the host pipe such that the expandable tubes carry almost all internal and/or external loads.

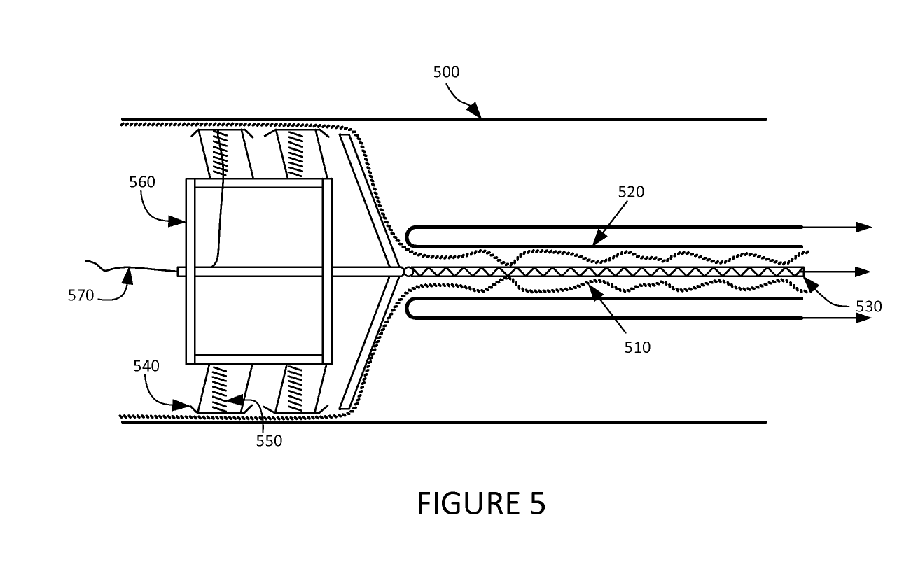

A dry expandable tube may be saturated with a resin such as an epoxy to form, for example, a Fiber Reinforced Polymer (FRP) tube capable of resisting loads. There are several ways to saturate an expandable tube including but not limited to:
a) Saturating the tube before inserting it into the pipe;
b) Inserting the dry tube into the pipe and spraying epoxy on the tube as the tube is pushed against the surface of the pipe;
c) A combination of a) and b) where the tube is resin saturated outside the pipe but when/if necessary additional resin is applied to the tube inside the pipe;
d) Introducing the dry tube into the pipe and passing it through a bath of resin inside the pipe so that the tube becomes saturated before it is installed on the wall of the pipe; and
e) Placing the tube inside a thin long plastic cover and forcing resin inside the plastic cover. Subsequently inserting the plastic-covered-tube into the pipe and inverting the plastic cover so it is peeled off and removed from the resin saturated tube, as shown in FIG. 5.

In some embodiments, the expandable tube is saturated with epoxy before entering the pipe. The preferred epoxy is QuakeBond™ Heat Cured Resin that has a very long shelf life (more than 24 hours) at ambient temperature. This allows the saturation of the expandable tube several hours before it is installed and provides a higher efficiency and shorter installation time. This resin cures in only 2-5 minutes when it is subjected to a temperature of 250-300 degrees Fahrenheit.

Some of the advantages of the present methods are:
1. A flexible braided carbon tube can be designed to resist high pressures independent of or in conjunction with the host pipe (depending on which design alternative is selected);
2. Long segments of pipe (over 2,000 feet) can be repaired in a single step;
3. The trenchless technique only requires a small access point (less than 12-inch in diameter) at each end of the repair segment;
4. The CFRP (Carbon Fiber Reinforced Polymer) tube liner offers excellent durability and long service life;
5. The long pot-life (period for which two mutually reactive chemicals remain usable when mixed) of the resin at ambient temperature makes the repairs easier;
6. The unique construction of the flexible braided tubes allows them to be installed through elbows and bends; the diameter of the tube will change in these regions allowing the tube to remain in full contact with the host pipe at all points throughout the bend; conventional FRP liners create a choke point at those locations;
7. The flexible braided tubes and the present techniques are very cost-effective.

In one embodiment, such as the one illustrated in FIG. 4, an inflatable bladder 420 (also known as a packer) is placed inside the resin-saturated expandable tube 410 and the surface of this bladder is covered with heating elements. The inflatable bladder 420 can be inflated to push the expandable tube 410 against the inside surface of pipe 400 and keep the inflatable bladder 420 and the resin-saturated expandable tube 410 in the same position for 2-5 minutes while the heat of the heating elements cure the epoxy resin. Bladder 420 can be designed to have a sufficient segment in contact with the expandable tube 410 so that the whole assembly travels at a rate of 1 foot or so per minute, which corresponds to repairing the pipe 400 at the same rate of 1-ft per minute. Bladder 420 can move by either an electrical or other type of motor or simply can be pulled by a rope 440 at the required speed to allow full curing of the resin.

As shown in FIG. 4, in some embodiments a resin spray 430 may proceed bladder 420 and may spray resin on a pervious and penetrable expandable tube 410. This is in lieu of or in addition to saturating the expandable tube 410 before insertion into the pipe 400.

Linings of adjacent pipe sections are overlapped by a few inches or feet to create a continuous lining within the pipe. Preferably, the overlap is in the direction of the flow (like shingles on a roof) to make sure that the fluids flowing in the pipe will not seep between the lining and the host pipe.

Examples of the heating elements are those manufactured by LaminaHeat in Massachusetts that are very thin and can provide uniform high temperatures, in the range of 200-350 F, that are required for the curing of the epoxy. In some embodiments the bladder itself can be filled with hot air, steam or gas so that as the bladder (or packer) pushes the expandable tube against the host pipe, it will also cure it.

In various embodiments, such as the one shown in FIG. 5, one or more cylindrical-shaped devices 560 with multiple curved heating surfaces 540 may be used to expand and stick the expandable tube 510 to the inside surface of pipe 500 and cure the resin. In such devices the spring loaded heating surfaces 540, for example, have the twin roles of pushing the tube 510 against the inside surface of pipe 500 and heating the resin for curing. Springs 550 keep heating surfaces 540 pushing against the inside surface of pipe 500 at all times unless, for example, string 570 is pulled for some reason. In some embodiments the above mentioned LaminaHeat can be used as a coating to be glued or otherwise affixed to the curved heating surfaces 540 to assist with and expedite the curing of the resin. FIG. 5 also shows that as cylindrical-shaped devices 560 is being pulled forward, the cover-sheet 520, which covers the expandable tube 510, is being peeled away from expandable tube 510 to allow the expandable tube 510 to be expanded by cylindrical-shaped devices 560.

In some embodiments the heating surfaces 540 may be coated with a resin mixed with carbon nanotubes such as those manufactured by Boyce Components (Phoenix, Ariz.). These products cure to form a coating on the surface of the heating element and when an electrical current is passed through them, they provide a uniformly heated surface that can efficiently cure the resin applied to the expandable tube.

In some embodiments the cylindrical device 560 can include a motor to make it move/travel inside the flexible tube 510 at a desired speed. Such devices 560 can be either directly connected to an electrical cable (tethered mode) or operated remotely, for example by an operator who is outside the pipe. In another embodiment the cylindrical device 560 can be pulled with a winch or similar devices containing a cable, rope, chain 530, and the like.

The above tools can also be used when the pipe is large enough for man entry. In such cases the crew can use these devices in addition to their own tools to saturate and push the flexible tube against the host pipe. In some embodiments the crew working inside the pipe can move the cylindrical device at the desired speed to cure the resin-saturated flexible tube.

In some embodiments the primary method of curing the resin is to use heating blankets to heat a flexible tube saturated with special resin [QuakeBond™ 350HC (Heat Cured) Resin]. This resin cures in 2 minutes when it is heated to a temperature of 350 F. In other embodiments, resins that are cured in ambient condition, which may take up to a few hours to cure, can be used. In other embodiments, UV-Cured resin, or hot steam and the like can be used to cure the resin.

In various embodiments the entire lining procedure can be repeated as many times as desired. For example, the first flexible tube may have most of the fibers in the longitudinal direction (along the length of the pipe to resist thrust loads) and the next flexible tube(s) may have most of their fibers in the hoop direction (to resist hoop stresses that are generated when the pipe is pressurized). The number of flexible tubes and the orientation of fibers within each flexible tube is a task that engineers determine based on the loading and strength requirements of the pipe.

In other embodiments the flexible tube can be incorporated with a 3D fabric or a honeycomb sheet. Such 3D fabric or honeycomb core can be applied between layers of flexible tube and add significant stiffness and strength to the repair liner. These combinations are particularly useful when a pipe repair has to be designed to resist external gravity loads in addition to the internal pressure.

In another embodiment one or more thin layers of a fabric or tube called a “veil” can be installed between the pipe and the flexible tube and/or on the inside surface of the flexible tube. This veil has multipurpose such as preventing galvanic corrosion, creating an impervious and watertight membrane inside the pipe, etc. The veil is typically made from a lightweight glass or polyester chopped mat or twisted yarn or biaxial fabric.

In other embodiments additional coatings can be applied on top of the installed flexible tube for further resistance to chemicals or for added durability, abrasion resistance, water tightness and the like. Those skilled in the art realize that numerous such products are available in the market and can be incorporated in the repair methods described here. Such coatings can be applied by brushing, rolling or spraying methods and the like.

In yet other embodiments, it may be required to drill or otherwise tap into the pipe to connect other pipes and fittings to the repaired pipe. As known to those skilled in the art, there are currently techniques for performing such tasks. In one example, the coordinates of these connections are accurately mapped and recorded before the repair and once the flexible tube is installed robotics drills can cut those holes from inside the pipe, allowing the connections to be re-made. Likewise, if the pipe is accessible from outside, the pipe and the flexible tube liner can be drilled through from the outside surface of the pipe to accommodate installation of connections and fittings.

In another embodiment, the techniques detailed above can be used to construct a new pipe. As an example, a lightweight form/tube or mold such as a cardboard sonotube can be used as a mold (instead of a pipe) and the procedure above can be followed to cure one or more layers of flexible tube inside the mold. This creates a cylindrical structure (a pipe) that can be removed by slipping it off of the mold. In some embodiments, the mold can be torn to expose the pipe; this has the disadvantage that the mold will be destroyed and not useable after its first use. In other embodiments, a layer of bond breaker can be applied to the inside of the mold, allowing the finished pipe to be slid off the mold without damaging it, allowing the mold to be reused.

In another embodiment the mold can be made of several sections of a more durable material such as steel or fiberglass that are connected or bolted together to form a mold. Once the pipe has been constructed inside the mold using one or more layers of flexible tube, then the mold can be taken apart and the finished pipe is removed. Such molds can be used repeatedly. With these methods any desired curved shape sections (rather than a straight cylinder segment) can be produces to construct fittings such as 45 degree bends and the like. These fittings (constructed in various angles) can be connected to the straight pipe segments to create any desired pipe geometry and alignment for any project.

In some other embodiment, the pipe may be constructed without the need for an external mold. One example is to use the inflatable bladder as the device determining the final diameter and shape of the pipe. For example, if a 20-ft long×12-inch diameter pipe is to be constructed, a piece of the flexible tube longer than 20 feet is saturated. This flexible tube will be designed to have a diameter of approximately 12 inches when it is stretched. The resin saturated flexible tube is pulled over the deflated bladder and then the bladder is inflated to form a cylinder 20-ft long×12-inches in diameter. The flexible tube is cured in that condition and then the bladder is deflated and pulled out, leaving the newly-constructed pipe behind. In such a case, it may be easier to heat and cure the flexible tube from outside since the outside face is readily accessible. In some embodiments, the bladder can provide the heat for curing by hot water, air, steam, hot gas and the like. The ends of such a pipe can be trimmed for future connection to other pipe segments.

In another embodiment, a collapsible rigid mandrel constructed of such materials like steel or fiberglass and the like can be used. The resin-saturated flexible tube can be pulled on top of (i.e. the outside surface of) the collapsible mandrel and the mandrel is activated to expand outwards to the desired diameter (or size if the mandrel is not cylindrical, for example when making a 45 degree bend fitting). Then the resin is cured from outside or from heating elements that are a part of the skin of the collapsible mandrel. Once the resin is cured, the mandrel is collapsed and pulled away, leaving the finished tube, pipe, fitting or shape behind.

The tubular structure can be further enhanced by including one or more layers of 3D fabric or honeycomb core saturated with resin and subsequently cured. In one embodiment, for example a tube can be made with a single layer of flexible tube, and then additional layers of 3D fabric and/or honeycomb core can be wrapped around that to create a much stiffer structure. Such a stiff tubular structure can be used as a stay-in-place form in construction where it can be filled with concrete and or reinforcing steel to create a column, a pile for marine construction, a utility pole, etc.

The expandable tubes can be designed to be directly attached to the inside surface of the pipe and resist the loads jointly with the pipe material. On the other hand a thin layer of compressible material may be added between the pipe and the expandable tube to transfer all or most stresses resulting from all or most loads (both internal pressure and external loads from traffic, soil, etc.) to the expandable tube material. This is because while the tube expands as a result of internal forces of the pipe, the expansion of the tube deforms the compressible material layer which will not transfer the forces to the pipe. In other words, while calculating the allowable pressure in pipes repaired with the mentioned liner tubes, it is important to recognize the fact that the liner tube will stretch as it is subjected to internal pressure. Therefore, it is possible to first line the pipe with a thin coat of a compressible material. This material can be sprayed on the pipe surface. Depending on the pipe diameter, a small thickness, such as 0.05 inch, may be sufficient. With such an arrangement, the liner tube can be designed to take the entire operating pressure of the pipeline, relieving the old steel pipe of any internal pressure. As the liner tube is pressurized, its expansion will cause a reduction in thickness of the sprayed compressible coating without transferring any or very small amount of the pressure to the host pipe. This method creates “a pipe inside a pipe” and fully protects the outer pipe since the original/outer pipe may not be relied upon for any future operations once the lining is complete.

Those skilled in the art realize that while the main concepts have been introduced here using pipe as an example, the application of these embodiments goes much further. For example, the tubes described above can be used as a pipe but also in a smaller scale as structural elements (tubes) that are used to construct bicycle frames, motorcycles, automotive parts, structural tubing for columns and supports in buildings, bridges, piles, utility poles and the like.

Those skilled in the art will appreciate that many other honeycomb type layers, hollow structures, or laminate structures are possible without departing from the spirit of the present disclosures. For example, the honeycomb cells may be constructed in any geometric form, such as rectangle, hexagon, and the like to serve the same purpose. Likewise, other spacer materials such as foams, polyurea and the like can be used to achieve higher strength and stiffness.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of reinforcing or repairing a pipe, the method comprising:
placing at least one resin-saturated flexible and/or radially-expandable tube inside the pipe, along a desired length of the pipe that is being repaired or reinforced, wherein the tube is resin saturated outside of the pipe, inside of the pipe, or both inside and outside of the pipe; and
attaching the tube to inside surface of the pipe by moving an expansion device inside and along the length of the tube, wherein the expansion device is configured to push the tube outwardly against the inside surface of the pipe.

2. The method of claim 1 wherein the flexible and/or radially-expandable tube is constructed from braided tows or fibers.

3. The method of claim 2 wherein the fibers of the braided tube are carbon, glass or basalt.

4. The method of claim 1, wherein the resin is an epoxy and is further cured by heating it to 250 F to 350 F.

5. The method of claim 1, wherein the expansion device is an inflatable bladder or balloon.

6. The method of claim 1, wherein the expansion device is a device that includes spring-loaded curved components that match the curvature of the inside surface of the pipe.

7. The method of claim 1, further comprising curing the resin by an electrical heating element, steam or hot air.

8. The method of claim 1, further including applying a protective coating to the inside surface of the tube.

9. The method of claim 1, further including a compressible coating or a compressible layer between the pipe and one of the tube layers.

10. The method of claim 1, wherein one of the reinforcing tubes of a multi-tube lining is a 3D fabric or a honeycomb core.

11. A method of reinforcing or repairing a pipe, the method comprising:
applying a coat of a compressible material on an inside surface of the pipe;
placing an adhesive-saturated flexible and/or radially-expandable tube inside the coated pipe, wherein the tube is adhesive saturated outside of the pipe, inside of the pipe, or both inside and outside of the pipe; and
adhering the tube to the inside coating of the pipe by moving an exapnsion device inside the tube wherein the expansion device is configured to expand the tube and presses the tube against the coating of the pipe.

12. The method of claim 11, further comprising an adhesive-saturated 3D fabric or honeycomb core as a reinforcement layer.

13. The method of claim 11, wherein the expandable mandrel is an inflatable bladder or balloon or a semi-rigid structure with spring-loaded curved surfaces.

14. The method of claim 13, where the curved surfaces of the spring-loaded mandrel further include electrical heating pads.

15. The method of claim 11, further including curing the adhesive by an electrical heating element.

16. A method of constructing a tubular structure, the method comprising:
providing a tubular mold having an interior surface substantially representing shape and size of the tubular structure;
placing at least one resin-saturated radially-flexible tube inside the tubular mold, wherein the tube may be resin saturated outside of the mold, inside of the mold, or both inside and outside of the mold; and
forcing the tube against the interior surface of the mold by expanding and optionally moving an expandable device inside the tube.

17. The method of claim 16, further comprising curing the resin-saturated radially-flexible tube and removing the mold from the cured and expanded tube.

18. The method of claim 16, wherein the expandable device is stationary or mobile within the tube.

19. The method of claim 16, wherein a sheet of material forming the expandable tube is either stretchable or is in a folded position and unfolds while the tube expands radially, or is both stretchable and is in a folded position and unfolds while the tube expands radially.

20. The method of claim 16, further including adding a resin-saturated tube of 3D fabric or honeycomb core.
